(19) United States
(12) Patent Application Publication
(10) Pub. No.: US 2007/0260400 A1
(43) Pub. Date: Nov. 8, 2007

(54) Computerized crop growing management system and method

(76) Inventors: Omry Morag, Hefer (IL); Lior Doron, Zichron-Yaacov (IL)

Correspondence Address: NATH & ASSOCIATES, 112 South West Street, Alexandria, VA, 22314, US

(21) Appl. No.: 11/417,263

(22) Filed: May 4, 2006

(51) Int. Cl. G06F 19/00

(52) U.S. Cl. 702/1; 702/127; 702/189

(57) ABSTRACT

The present invention discloses a computerized method of crop growing management and a system thereof. The method comprises receiving operational data and/or derivatives thereof and field data and/or derivatives thereof related to one or more crop growing blocks, and processing at least part of the received data so as to define cross-related data among the received data and/or discrepancy thereof. The method further comprises displaying the results, for example as a bar-chart comprising one or more bars representing time-phased activity durations related to at least part crop growing blocks.

### FIELD OF THE INVENTION

This invention relates to controlled crop growing in agriculture and landscaping, and in particular, to crop growing management.

### BACKGROUND OF THE INVENTION

Nowadays crop growing management, including management of irrigation and/or climate control, is an important part of agriculture and landscaping. Problems related to controlled crop growing have been recognized in prior art and various systems have been developed to provide a solution, for example:

U.S. Pat. No. 4,015,366 (Hall) entitled “Highly automated agricultural production system”;

U.S. Pat. No. 4,760,547 (Duxbury) entitled “Remote Controlled multi-station irrigation system with DTMF transmitter”;

U.S. Pat. No. 5,566,069 (Clark et al.) entitled “Computer network for collecting and analyzing agronomic data”;

U.S. Pat. No. 5,173,855 (Luck) entitled “Distributed multiple irrigation controller management system” U.S. Pat. No. 5,771,169 (Wendte) entitled “Site-specific harvest statistics analyzer”;

U.S. Pat. No. 6,076,740 (Townsend) entitled “Irrigation control system”;

U.S. Pat. No. 6,950,728 (Addink et al.) entitled “Interactive irrigation system”;

US Patent Application No. 2001/16,788 (Hauwiller) entitled “System and method for creating agricultural decision and application maps for automated agricultural machines”;

US Patent Application 2002/20,441 (Addink) entitled “Irrigation controller”;

US Patent Application No. 2003/183,018 (Addink et al.) entitled “Flow meter as irrigation management tool”;

US Patent Application No. 2004/181,315 (Cardinal et al.) entitled “Irrigation system”;

US Patent Application 2006/30,990 (Anderson et al.) entitled “Method and system for estimating an agricultural management parameter”;

Chinese Patent Application No. 1586125 (Chen) entitled “Managing and control system for crops in greenhouse”.

### SUMMARY OF THE INVENTION

In accordance with certain aspects of the present invention, there is provided a computerized method of crop growing management comprising:
(a) receiving operational data and/or derivatives thereof and field data and/or derivatives thereof, thus giving rise to received data;
(b) processing at least part of the received data so as to define at least one type of results selected from a group comprising:
   i) cross-related data among the received data;
   ii) discrepancy among the received data;
   iii) status of at least part of activities comprised in a crop growing schedule, wherein said status is defined based on the received data.

In accordance with further aspects, the method comprises displaying at least part of said results of the processing and/or derivatives thereof. The received data may be related to one or more crop growing blocks and/or controllers; and the crop growing schedule may be displayed as a bar-chart comprising one or more bars representing time-phased activity durations related to at least part of said crop growing blocks.

In accordance with further aspects of the present invention the method comprises updating at least part of the crop growing schedule and/or sending an alert and/or deriving at least one control command to be sent to one or more crop growing controllers if the defined discrepancy matches a certain criterion.

The method may further comprise receiving at least part of a crop growing program, wherein at least part of the received data is processed together with at least part of data comprised in the crop growing program so as to define at least cross-related data among the received data and the growth program and/or discrepancy among the received data and the growth program data and/or status of at least part of activities comprised in a crop growing schedule, wherein said status is defined base on the received data and the crop growth program.

In accordance with further aspects of the present invention the method comprises deriving one or more recommendations in accordance with defined discrepancy and/or updating at least part of the crop growing schedule if the defined discrepancy matches a certain criterion and/or sending an alert if the defined discrepancy matches a certain criterion and/or deriving at least one control command to be sent to one or more crop growing controllers if the defined discrepancy matches a certain criterion and/or displaying at least part of results derived from said operations.

The method may further comprise receiving landscape data, wherein at least part of the received data is processed together with the landscape data and the crop growing program data so as to define cross-related data and discrepancy thereof in view of the crop growing program data and the landscape data.

In accordance with other aspects of the present invention there is provided a computerized method of crop growing management comprising:
(a) receiving operational data and/or derivatives thereof and field data and/or derivatives thereof thus giving rise to received data related to one or more crop growing blocks;
(b) receiving a crop growing program;
(c) processing at least part of the received data together with at least part of data comprised in the crop growing program so as to define at least one result selected from a group comprising:
   i) cross-related data among the received data and the growth program data;
   ii) discrepancy among the received data and among the received data and the growth program data;
   iii) status of at least part of activities comprised in a crop growing schedule, wherein said status is defined based on the received data and the growth program data.

In accordance with further aspects of the present invention the method comprises displaying the results of said processing and/or derivatives thereof as a bar-chart of time-phased activity durations related to said crop growing blocks, wherein at least part of the bars comprises information related status of the represented activity and/or at least one planned parameter related to the represented activity and/or operational data related to the represented activity and/or field data related to the represented activity and/or discrepancy between at least one planned parameter and operational data related to the represented activity and/or discrepancy between at least one planned parameter and field data related to the represented activity and/or discrepancy between cross-related received data related to the represented activity and/or discrepancy between cross-related received data and the growing program data.

The method may comprise processing based on at least one adapting algorithm and/or data mining algorithm.

In accordance with other aspects of the present invention, there is provided a managing system for crop growing management comprising:
(a) a data repository configured to receive and store operational data and/or derivatives thereof and field data and/or derivatives thereof, thus giving rise to received data;
(b) a processor operatively connected with the data repository and configured to process at least part of the received data so as to define cross-related data;
(c) a display operatively connected with the processor and configured to display at least part of results of the processing and/or derivatives thereof.

In accordance with further aspects of the present invention the management system is configured to receive and/or store operational data and/or field data and/or landscape data and/or crop growing program data. At least part of said data may be received from a source external to the managed crop growing system; at least part of said data may be stored in the system as historical data.

In accordance with other aspects of the present invention there is provided a method of computerized crop growing management based on a control loop comprising:
(a) receiving operational data and/or derivatives thereof and field data and/or derivatives thereof, thus giving rise to received data;
(b) processing at least part of the received data so as to facilitate verification of operational parameters related to the control loop and to provide a corresponding feedback.

In accordance with other aspects of the present invention there is provided a method of computerized crop growing management comprising:
(a) receiving data related to one or more crop growing blocks, and
(b) displaying a crop growing schedule as a bar-chart comprising one or more bars representing time-phased activity durations related to at least part of said crop growing blocks.

Those skilled in the art will readily appreciate that crop growing systems and methods are aimed not only to meet water demand, but also to many other aspects as, for example, to deliver fertilizer, pH control and similar products to the crop; to flush salt build-up from the soil; to cool the soil surface to prevent high temperature damage to tender crops (seedlings); to humidify the air and reduce crop wilting and stress, to fumigate, to provide a uniform moisture level of the crop before packing and shipping, and to other purposes related to effective crop growing and landscaping. Among advantages provided in accordance with certain aspects of the present invention is ability of crop growing control in accordance with desired crop growing parameters together with operational and real field parameters; ability of data verification for management decision; ability to provide and display information with relation to real status of the crop growing blocks, etc.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a generalized block diagram of exemplary crop growing system architecture, in accordance with an embodiment of the invention;

FIG. 2 illustrates a generalized flow diagram showing the principal operations of a crop growing management system in accordance with an embodiment of the invention; and

FIG. 3 illustrates a fragment of a sample screen comprising displayed management-related information in accordance with certain embodiments of the present invention.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “deriving”, “generating” or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as, processor, computer, apparatus, system, sub-system, module, unit, device (in single or plural form) for performing the operations herein. This may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, Disk-on-Key, smart cards (e.g. SIM, chip cards, etc.), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions capable of being conveyed via a computer system bus.

The processes/devices presented herein are not inherently related to any particular electronic component or other apparatus, unless specifically stated otherwise. Various general purpose components may be used in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The references cited in the background teach many principles of computerized crop growing that are applicable to the present invention. Therefore the full contents of these publications are incorporated by reference herein where appropriate for teachings of additional or alternative details, features and/or technical background.

The term “actuator” used in this patent specification includes any device used to convert an electrical or other control signal to a physical action. Actuators may be used for any physical resources of computerized crop growing system, e.g. flow-control valves, pumps, filters, positioning drives, motors, switches, relays, meters, etc.

The term “criterion” used in this patent specification should be expansively construed to cover any compound criterion, including, for example, several criteria and/or their combination.

The term “computerized crop growing” used in this patent specification should be expansively construed to cover any process or combination thereof related to crop growing in agriculture and/or landscaping and, at least partly, controlled by computer, e.g. irrigation, climate control, fertilizing, fumigating, etc.

The term “crop growing schedule” is a schedule comprising a set of activities, including their parameters (e.g. volume, runtime, flow rates, amount and composition of the fluid to be delivered, rules for opening of greenhouse windows, etc.), associated rules, control commands, etc. related to operation of at least part of a computerized crop growing process. The set of activities may be related to different crops and corresponds for one or more crop growing programs.

The term “cross-related data” used in this patent specification should be expansively construed to cover any data or derivatives thereof received from different sources (including measured, estimated, calculated and/or predefined values of the data) and related, directly or indirectly, to the same parameter to be controlled and/or to different parameters comprised in one calculating equation for another parameter to be controlled. The cross-related data may be also related to the same condition (e.g. criterion) in one or more rules, in one algorithm, etc.

The term “discrepancy” used in this patent specification should be expansively construed to cover any compound discrepancy, including, for example, several discrepancies and/or their combination.

The term “environmental data” used in this patent specification includes any data about the environment related to the growing crop or parts thereof, including evapotranspiration (ETo) data, rainfall data, weather information, etc.

The term “fluid” used in this patent specification includes any kind of liquid, as well as gases and/or solids in liquids either in dissolved or particulate form (e.g. water, agricultural chemicals dissolved in water, etc.) useful in an irrigation system.

The term “irrigation” used in this patent specification includes any process of applying a fluid to a specific area for crop growing in agriculture and/or landscaping, including fluid supply, fertilizing, filter flushing, nutrient management, cooling, misting and other applications.

The term “landscape data” used in this patent specification includes any practically invariable during crop growing process data about a specified part and/or entire landscape associated with the growing crop. Landscape data includes topographical data, soil type data, landscape slope data, plant type, etc.

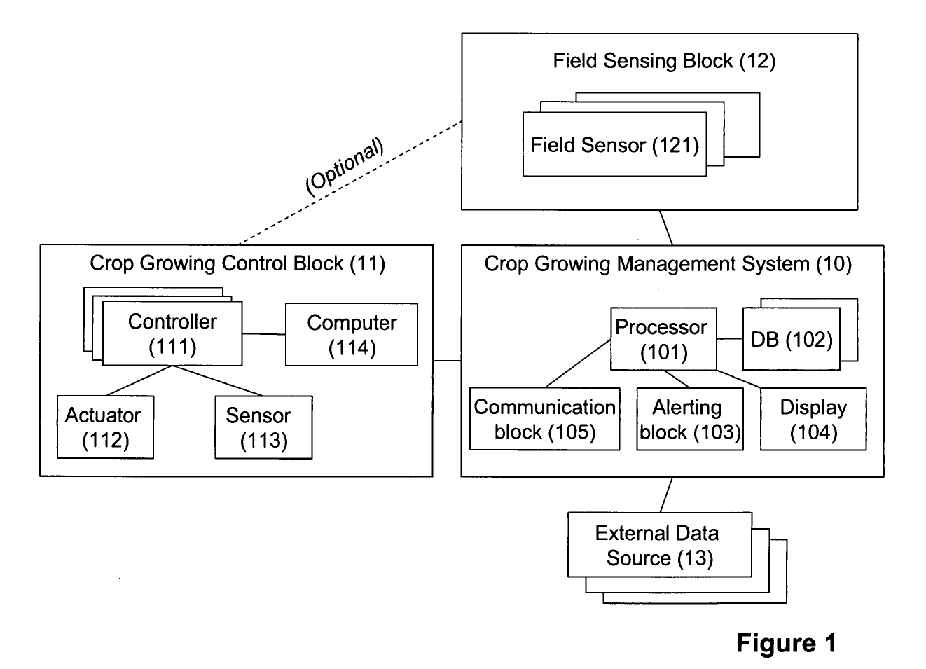

Bearing the above in mind, attention is drawn to FIG. 1 schematically illustrating a generalized block diagram of a computerized crop growing system. In accordance with certain embodiments of the present invention, a computerized crop growing management system 10 (also referred to hereinafter as the management system) is operatively connected with a computerized crop growing control block 11 (also referred to hereinafter as the control block), field sensing block 12 and, optionally, one or more external data sources blocks 13. The management system 10 may be implemented in a single computer or its functionality may be distributed among several different computers running several applications. In certain embodiments of the present invention the management system may be implemented as a web server-based host. The connection may be provided directly or via Wire-line, Wireless, cable, Internet, Intranet, power, satellite or other networks, using any suitable communication standard, system and/or protocol and variants or evolution thereof. In certain embodiments of the invention the connection between the above blocks 11, 12 and 13 and the management system 10 may be configured to provide bi-directional exchange of information, while in other embodiments at least part of the connections may be configured only to transmit information to the management system.

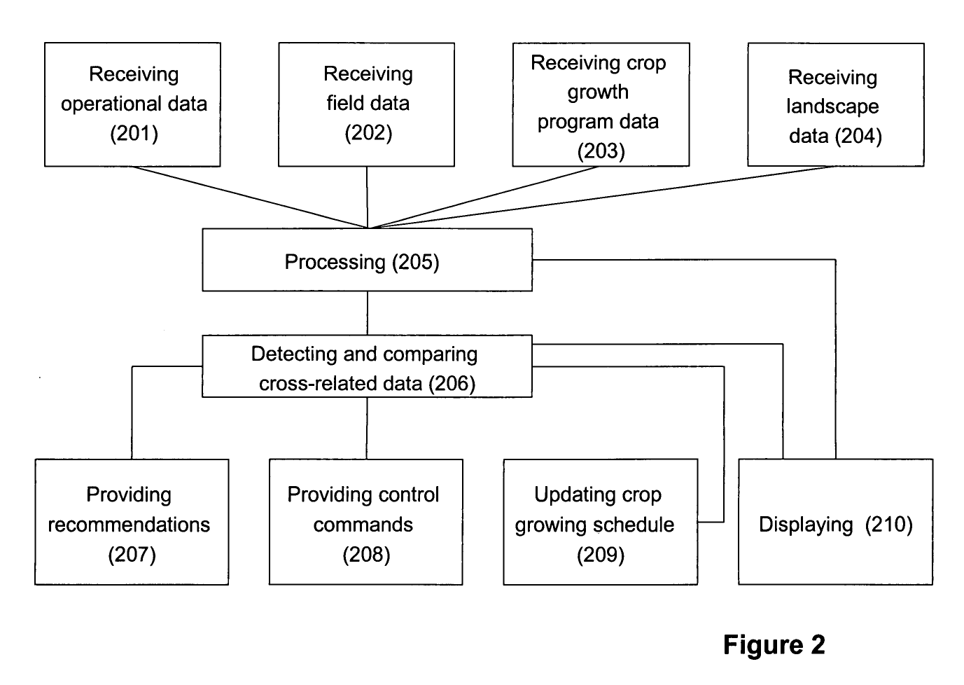

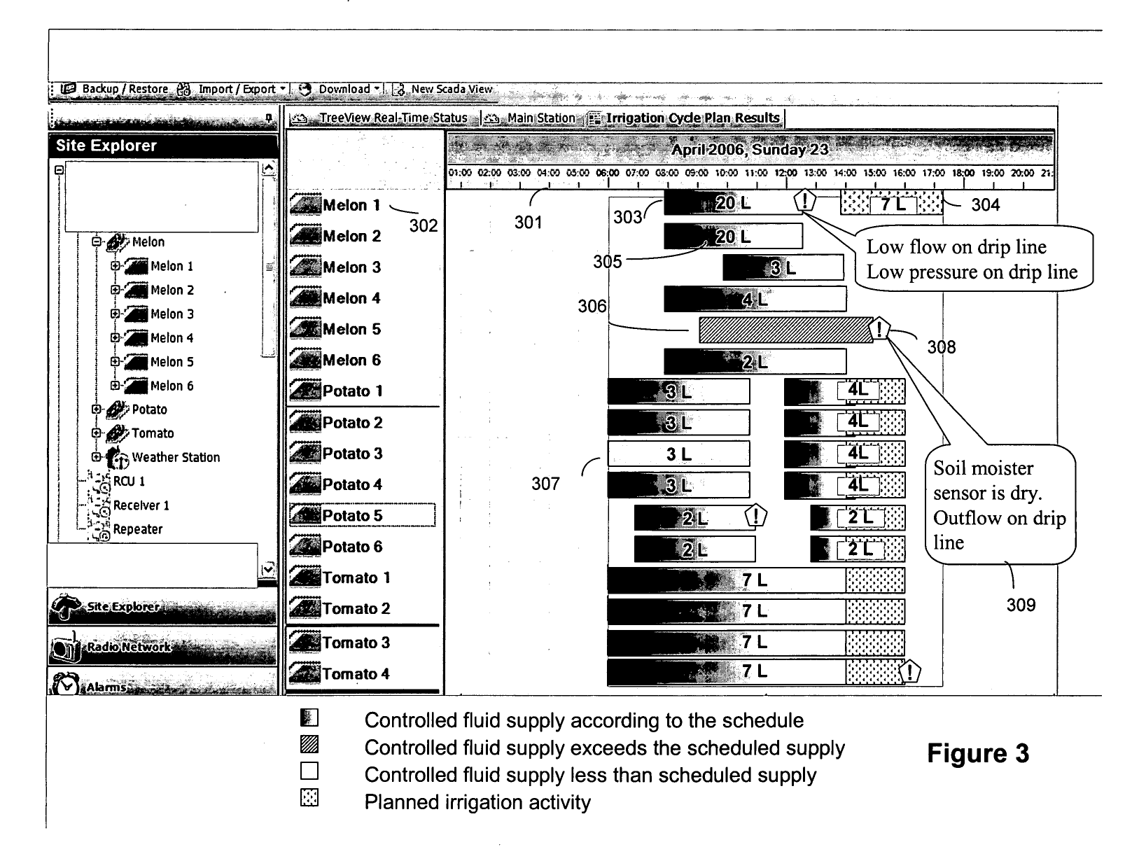

As will be further detailed with reference to FIGS. 2 and 3, the management system is configured to process the information received from at least one of the above blocks and to provide at least one of the following:
a) to generate a crop growing schedule or update an existing one;
b) to generate one or more control commands to the control block;
c) to generate one or more recommendations;
d) to generate one or more alerts;
e) to display the results.

The generated/updated crop growing schedule or parts thereof may be downloaded to the control block or parts thereof, and/or displayed, and/or used to generate control commands and/or recommendations. The control commands and/or recommendations may be comprised in the crop growing schedule, generated on a base of the schedule and/or generated in accordance with predefined rules comprised in the management system.

In certain embodiments of the invention the management system may be also configured to detect operational and/or field problems and/or their reasons.

The management system 10 contains a processor 101 linked with one or more data repositories 102. The data repository 102 comprises current (and, optionally, historical) data and/or derivatives thereof obtained from the control block and the field sensing block. The data repository may also store data and/or derivatives thereof received from external sources (e.g. different inputs by one or more users, predefined landscape data, weather forecast from a weather agency, historic ETo values from a water agency, etc.). The data repository may comprise parameters, conditions and/or algorithms related to problem evaluation procedures, contingency rules related to operating the crop growing system or part thereof upon detection of one or more problems, etc. The data repository may store a variety of crop growing programs; landscape data, predefined crop growing schedules (e.g. dosing fertilizers for different crops, automation and perfusion schedules for different climate conditions and crop needs, spraying schedules, etc.); harvest time changing the irrigation plan according to the plant season; rules (and associated parameters and conditions) for generating control commands, recommendations and/or alerts; previously generated recommendations for different crop growing scenarios as well as historical results of different scenarios' implementation; etc. The data repository may also comprise algorithms and programs for crop growing optimization, including algorithms for adaptive optimization based on historical data.

The processor 101 provides processing and management of data received by the management system and/or stored in the data repository. The processor executes calculations and data management necessary for the crop growing management process in accordance with the present invention. In certain embodiments of the invention the processor may contain algorithms and programs for analysis of the crop growing process and evaluation of obtained results. In certain embodiments of the invention the processing functionality may be distributed between various processing components connected directly or indirectly; or/and a part of said calculations and/or data management may be executed by external systems.

In certain embodiments of the invention the processor 101 is configured to evaluate matching the acquired data and/or derivatives thereof to a certain criterion. Accordingly, if the criterion corresponds to a certain problem, the processor may be configured to send a notice to an alerting block 103 if a problem is detected. The alerting block is capable of providing audio, visual, telecommunication (e.g. SMS, e-mail, call, etc.) or other indication in accordance with the received notice.

In certain embodiments of the invention the management system includes also communication block 105. This block is configured to send information to one or more third parties (e.g. for billing purposes, monitoring, etc.). The communication block may be also configured to support a user interface(s) allowing one or more users to exchange information with the management system and/or to configure and monitor the crop growing system via a network. Communication with the control block 11, field sensing block 12 and external data source(s) 13 may be provided via one or more dedicated interfaces (not shown in FIG. 1) or/and via the communication block 105.

The control block 11 comprises one or more controllers 111 (e.g. irrigation controllers, climate controllers, fumigation controllers, pump station controllers, filter flush controller, water sources management controller, frost protection controller, fertilizers dosing system controllers, etc.) wherein each controller is operatively coupled to at least one actuator 112 capable of receiving a signal from the associated controller and convert it to a physical action related to at least one resource of the crop growing system (e.g. irrigation valves, greenhouse shade screens, sprinklers, pumps, filter flushing valve, hitting pump or boiler, dosing valve, electric motors, etc.). Optionally the control block may also comprise one or more computers 113 operatively connected to the controllers 111. The computer 113 is capable of exchanging information and control commands with the controller 111. In certain embodiments of the invention the functionality of the computer 113 or part of it may be integrated with the controllers. In certain embodiments of the invention the computer 113 may be configured as a “slave” computer of the management system 10, and part of the management system functionalities may be delegated to the computer 113 (e.g. the management system may calculate and/or update the crop growing schedule, while the computer 113 may provide the controllers with control commands in accordance with said schedule). The controller 111 controls operation of corresponding actuator 112 in accordance with crop growing schedule and/or received control commands. The schedule and/or control commands may be predefined, fully or partly calculated by the controller, fully or partly received from the computer 113 and/or management system 10 or any combination thereof.

The control block 11 may comprise one or more operational sensors 114 operatively coupled with one or more controllers. The operational sensors are capable of acquiring data related to operation of the crop growing system resources (e.g. water flow data, water pressure data, environmental data, rain gage, ET, dew point, radiation sum, etc.) associated with corresponding controller(s) and referred to hereinafter as “operational data”. The operational sensors may send the acquired operational data to the associated controller 111 and/or computer 113 and/or management system 10 and/or a combination thereof in a “push” mode in accordance with a predefined time schedule (e.g. hourly) and/or predefined event (e.g. start and end of specified activity, if acquired data meet predefined criterion, etc.); and/or the sensors may be interrogated by the associated controller 111 and/or computer 113 and/or management system 10 and/or a combination thereof. In certain embodiments of the invention the controller 111 and/or the computer 113 are configured to process the received data or part of them, and send the data and/or derivatives thereof to the management system.

It is to be understood that at least part of operational data may be entered into the controller 111, the computer 113 and or management system 10 manually or received from one or more external sources.

It is also to be understood that the parts of the control block may be placed in multiple geographical locations, be operatively grouped in accordance with location, function, ownership, etc., and be connected directly or via telecommunication network (e.g. Wire-line or Wireless Public Telephone Networks, Internet, Intranet, cable network, etc.). Those skilled in the art will readily appreciate that a control command received by controller may cause a corresponding direct response or request a manual intervention (e.g. for approval/disapproval of a corresponding action).

The field sensing block 12 comprises one or more sensors 121 referred hereinafter as “field sensors” and capable of measuring environmental data, soil parameters and/or crop parameters related to one or more specified crop growing blocks (e.g. specified plant(s), specified field areas, specified greenhouse areas, etc.) and communicate this data (referred hereinafter as “field data”) and/or derivatives thereof to the management system 10. It is also to be understood that at least part of the field data may be entered into the management system 10 manually (directly or indirectly), or received from one or more external sources.

The field sensors may send the acquired data to the management system 10 directly or via the control block. In certain embodiments of the invention transmitting the data from the field sensors via the control block 11 may be transparent, while in other embodiments at least part of the data may be processed by said block together or separately from the operational data. The data may be sent in a “pull” mode or in “push” mode in accordance with a predefined time schedule and/or predefined event. In certain embodiments of the invention the field sensing block may include a processor or computer (not shown in FIG. 1) capable of gathering, processing and storing data and/or derivatives thereof from the field sensors (and, optionally, other sources) and transmitting them, directly or indirectly, to the management system.

The field sensors may include soil moisture sensors; weather station sensors measuring temperature, humidity, solar radiation, wind speed and direction, leaf wetness and/or soil temperature); water meters; tensiometers, etc. The field sensors may be ground or plant mounted or may be remote sensors capable of acquiring specified plant(s) and/or specified area(s) related information (e.g. high resolution space borne multi-spectral sensors).

Those skilled in the art will readily appreciate that the invention is not bound by the configuration of FIG. 1; equivalent functionality may be consolidated or divided in another manner. In different embodiments of the invention, operative connections between the blocks and within the blocks may be implemented directly or indirectly, including remote connection. The remote connection may be provided via Wire-line, Wireless, cable, Internet, Intranet, power, satellite or other networks, using any communication standard, system and/or protocol and variants or evolution thereof.

Referring to FIG. 2, there is illustrated a generalized flow diagram of the principal operations of the computerized crop growing management system. In accordance with certain embodiments of the invention processing 205 is provided for at least two types of received data: operational data 201 and field data 202. In certain embodiments of the present invention the processing may also provided for growing program data 203 and/or received landscape data 204. At least part of the operational data and/or the field data may be received automatically from one or more corresponding sensors in accordance with a predefined time schedule and/or predefined event. The time schedule/predefined event may be different for different sensors and/or data. At least part of the crop growing program data and/or landscape data may be received during the processing from one or more external sources 13 or from the data repository 102. In certain embodiments of the invention at least part of the data to be processed may be manually entered by a user (e.g. via communication block 105).

In accordance with certain embodiments of the present invention at least part of data received from different sources (e.g. operational data and field data) may be cross-related. In accordance with certain aspects of the present invention, the processor is configured to recognize the cross-related data. The processor compare 206 the cross-related data or derivatives thereof, so as to find a discrepancy between them or with a certain criteria (e.g. planned value of corresponding parameter).

For example, a climate controller in a greenhouse may be connected to one or more operational sensors measuring temperature and humidity (operational data 201). The field sensors may measure, for example, the roots' temperature, the soil temperature and humidity of a specified crop growing block and leaf temperature (field data 202). While controllers known in the prior art run the control loop in accordance with data received from the operational sensors, in accordance with certain aspects of the present invention, the management system enables to meet the desired temperature and corresponding humidity by recognizing and comparing the cross-related data and providing the corresponding feedback to the control loop. In this greenhouse example the temperature and humidity data received from the operational and field sensors are cross-related. The discrepancy may be detected, for example, between the real soil temperature measured by the field sensor and the soil temperature estimated in accordance with the measured operational temperature; between desired soil humidity in accordance with the growing program and estimated per measured soil temperatures and/or per measured operational humidity; compound discrepancy between measured parameters and the desired optimized set of such parameters, etc.

The cross-related data may be related to the same and/or to different physical resources of the crop growing system. For example, in cultivating potatoes, the soil temperature in the picking period may be regulated by irrigation for cooling the ground. In this case the water-flow operational data may be cross-related with field soil temperature data.

The set of cross-related parameters may be predefined, generated by the management system in accordance with growing program during the operation, generated by the management system as a result of data mining among historical data, etc. In accordance with certain embodiments of the present invention, the identification of discrepancy is followed with at least one of the following, provided that the defined discrepancy meets a certain criterion:
a) generating one or more alerts and/or recommendations 207;
b) generating one or more control commands to the control block 208;
c) generating a crop growing schedule or updating an existing one 209;
d) displaying management-related information.

The criterion may be predefined, generated by the management system in accordance with growing program, generated by the management system as result of data mining among historical data, etc.

The received data and/or derivatives thereof and/or above results of processing and/or other management-related information may be displayed 210 locally or remotely. The content to be displayed may be pre-configured or configured by user. An example of displaying the management-related information for irrigation control is further detailed by way of non-limiting example with reference to FIG. 3. The displayed information may comprise at least one of the following:
at least part of the defined cross-related data;
at least part of defined discrepancies among defined cross-related data;
at least part of the updated irrigation schedule;
at least part of irrigation schedule comprising updated and corresponding non-updated activities;
one or more recommendations on further crop growing system operation; etc.

In certain embodiments of the invention the management process may include detecting operational and/or field problems and/or their reasons. This can be accomplished by setting parameters within which the crop growing system and parts thereof are determined to be operating effectively. If operation of the crop growing system (i.e. identified discrepancy) falls outside of one or more of the parameters (certain criterion), this indicates a problem. If a problem is detected, then the irrigation management system 10 may warn a user by sending a visible or audible signal. Severe problems may result in sending control commands to one or more control blocks to shut down of one or more resources of the crop growing system.

The identified discrepancy may point not only on operational/field problems. For example, discrepancy in the above greenhouse example may identify such problems as wrong placement of temperature and RH sensors, fails in the controlling loop, incorrect air flow structure within the greenhouse, etc.

FIG. 3 illustrates by way of non-limiting example a fragment of a sample screen comprising displayed management-related information in accordance with certain embodiments of the present invention. In the illustrated example irrigation activities of the crop growing schedule are displayed as a bar-chart. The bar-chart comprises a time scale 301 and the bars are related to time-phased activity durations per several crop growing blocks (plants in the current example) 302. The bars represent the actual 303 and planned activities 304 as well as their parameters 305 (e.g. volume of fluid to be supplied). The bars comprise indication (e.g. different colors) of activities' status in accordance with received operational data, for example the color indicates that in accordance with operational sensors melon 5 (bar 306) is supposed to be provided with more fluid than scheduled, and potato 3 (bar 307) is supposed to be provided with less fluid than scheduled. Some of the bars also comprise indication of discrepancy 308 (e.g. between operational and field data, between field data and growing program data, etc.). In certain embodiments of the invention the system provides (e.g. automatically or per user request) also a description of discrepancy 309 or consequence thereof and/or recommendations related to further operation of the crop growing system. For example: flow higher than expected; flow lower than expected; irrigation was done but the line flow meter showed zero; pressure during irrigation on the dripper line was lower than expected; pressure during irrigation on the dripper line was higher than expected; irrigation was completed according to the schedule but the soil moisture sensor shows dry soil; irrigation was completed according to the schedule but the dendrometer sensor (stem thickness changes sensor) shows no change, etc. In the current example, although in accordance with operational data melon 5 (bar 306) was supposed to be provided with more fluid than scheduled, discrepancy between operational and field data (soil moister sensor is dry) facilitates to detect the problem, namely outflow on a corresponding drip line.

Those skilled in the art will readily appreciate that the invention is not bound by the displaying illustrated in FIG. 3. The illustrated Gantt-like displaying may be grouped in another manner (e.g. with reference to controllers or any other resources of the crop growing system); the bars may represent several activities related to the same irrigation block and/or same resource; the bars may comprise indication of activity status in according with any received data, combinations and derivatives thereof. Those skilled of the art will also readily appreciate that the described management-related information may be displayed in another manner (e.g. as integrated SCADA presentation, etc.).

It is to be understood that the invention is not limited in its application to the details set forth in the description contained herein or illustrated in the drawings. The invention is capable of other embodiments and of being practiced and carried out in various ways. It should be noted that the invention is not bound by the specific algorithm of processing or specific structure. Those versed in the art will readily appreciate that the invention is, likewise, applicable to any other processing or presentation with equivalent and/or modified functionality which may be consolidated or divided in another manner.

It will also be understood that the invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A computerized method of crop growing management comprising:
(a) receiving operational data and/or derivatives thereof and field data and/or derivatives thereof, thus giving rise to received data;
(b) processing at least part of the received data so as to define at least one type of results selected from a group comprising:
i) cross-related data among the received data;
ii) discrepancy among the received data;
iii) status of at least part of activities comprised in a crop growing schedule, wherein said status is defined based on the received data.

2. The method of claim 1 further comprising displaying at least part of said results of the processing and/or derivatives thereof.

3. The method of claim 2 wherein the received data are related to one or more crop growing blocks, and the crop growing schedule is displayed as a bar-chart comprising one or more bars representing time-phased activity durations related to at least part of said crop growing blocks.

4. The method of claim 3 wherein at least one bar comprises information related to at least one information type selected from a group comprising:
(a) status of the represented activity;
(b) at least one planned parameter related to the represented activity;
(c) operational data related to the represented activity;
(d) field data related to the represented activity;
(e) discrepancy between at least one planned parameter and operational data related to the represented activity;
(f) discrepancy between at least one planned parameter and field data related to the represented activity;
(g) discrepancy between cross-related field data and operational data related to the represented activity.

5. The method of claim 2 wherein the received data are related to one or more crop growing controllers and the crop growing schedule is displayed as a bar-chart comprising one or more bars representing time-phased activity durations related to at least part of said crop growing controllers.

6. The method of claim 5 wherein at least one bar comprises information related to at least one information type selected from a group comprising:
(a) status of the represented activity;
(b) at least one planned parameter related to the represented activity;
(c) operational data related to the represented activity;
(d) field data related to the represented activity;
(e) discrepancy between at least one planned parameter and operational data related to the represented activity;
(f) discrepancy between at least one planned parameter and field data related to the represented activity;
(g) discrepancy between cross-related field data and operational data related to the represented activity.

7. The method of claim 1 further comprising updating at least part of the crop growing schedule if said processing is provided so as to define at least discrepancy among the received data, and the defined discrepancy matches a certain criterion.

8. The method of claim 1 further comprising sending an alert if said processing is provided so as to define at least discrepancy among the received data, and if the defined discrepancy matches a certain criterion.

9. The method of claim 1 further comprising deriving at least one control command to be sent to one or more crop growing controllers if said processing is provided so as to define at least discrepancy among the received data, and if the defined discrepancy matches a certain criterion.

10. The method of claim 7 further comprising deriving in accordance with updated crop growing schedule at least one control command to be sent to one or more crop growing controllers.

11. The method of claim 1 further comprising receiving at least part of a crop growing program, wherein at least part of the received data is processed together with at least part of data comprised in the crop growing program so as to define at least one type of results selected from a group comprising:
(a) cross-related data among the received data and the growth program;
(b) discrepancy among the received data and the growth program data;
(c) status of at least part of activities comprised in a crop growing schedule, wherein said status is defined base on the received data and the crop growth program.

12. The method of claim 11 wherein said processing is provided so as to define at least discrepancy among the received data and the growth program data, the method further comprising at least one of operations selected from a group comprising:
(a) deriving one or more recommendations in accordance with defined discrepancy;
(b) updating at least part of the crop growing schedule if the defined discrepancy matches a certain criterion;
(c) sending an alert if the defined discrepancy matches a certain criterion;
(d) deriving at least one control command to be sent to one or more crop growing controllers if the defined discrepancy matches a certain criterion;
(e) displaying at least part of results derived from the operations a) to d).

13. The method of claim 1 further comprising receiving landscape data, wherein at least part of the received data is processed together with at least part of the landscape data.

14. The method of claim 13 further comprising at least one of operations selected from a group comprising:
(a) deriving one or more recommendations in accordance with defined discrepancy and the landscape data;
(b) updating at least part of the crop growing schedule in accordance with the landscape data if the defined discrepancy matches a certain criterion;
(c) sending an alert if the defined discrepancy matches a certain criterion;
(d) deriving at least one control command to be sent to one or more crop growing controllers if the defined discrepancy matches a certain criterion;
(e) displaying at least part of results derived from the operations a) to d).

15. The method of claim 1 further comprising receiving a crop growing program and landscape data, wherein at least part of the received data is processed together with the landscape data and the crop growing program data so as to define cross-related data and discrepancy thereof in view of the crop growing program data and the landscape data.

16. A computerized method of crop growing management comprising:
(a) receiving operational data and/or derivatives thereof and field data and/or derivatives thereof thus giving rise to received data related to one or more crop growing blocks;
(b) receiving a crop growing program;
(c) processing at least part of the received data together with at least part of data comprised in the crop growing program so as to define at least one result selected from a group comprising:
i) cross-related data among the received data and the growth program data;
ii) discrepancy among the received data and among the received data and the growth program data;
iii) status of at least part of activities comprised in a crop growing schedule, wherein said status is defined based on the received data and the growth program data.

17. The method of claim 16 further comprising displaying the results of said processing and/or derivatives thereof as a bar-chart of time-phased activity durations related to said crop growing blocks, wherein at least part of the bars comprises information related to at least one information type selected from a group comprising:
(a) status of the represented activity;
(b) at least one planned parameter related to the represented activity;
(c) operational data related to the represented activity;
(d) field data related to the represented activity;
(e) discrepancy between at least one planned parameter and operational data related to the represented activity;
(f) discrepancy between at least one planned parameter and field data related to the represented activity;
(g) discrepancy between cross-related received data related to the represented activity;
(h) discrepancy between cross-related received data and the growing program data.

18. The method of claim 16 wherein said processing is provided so as to define at least discrepancy among the received data and the growth program data, the method further comprising at least one of operations selected from a group comprising:
(a) deriving one or more recommendations in accordance with defined discrepancy;
(b) updating at least part of the crop growing schedule if the defined discrepancy matches a certain criterion;
(c) sending an alert if the defined discrepancy matches a certain criterion;
(d) deriving at least one control command to be sent to one or more crop growing controllers if the defined discrepancy matches a certain criterion;
(e) displaying at least part of results derived from the operations a) to d).

19. The method of claim 18 wherein at least one of said operations comprises processing based on at least one adapting algorithm.

20. A managing system for crop growing management comprising:
(a) a data repository configured to receive and store operational data and/or derivatives thereof and field data and/or derivatives thereof, thus giving rise to received data;
(b) a processor operatively connected with the data repository and configured to process at least part of the received data so as to define cross-related data;
(c) a display operatively connected with the processor and configured to display at least part of results of the processing and/or derivatives thereof.

21. The managing system of claim 20 wherein the processor is further configured to define discrepancy among the cross-related data and to facilitate at least one of operations selected from a group comprising:
(a) updating at least part of the crop growing schedule if the defined discrepancy matches a certain criterion;
(b) deriving at least one control command to be sent to one or more crop growing controllers if the defined discrepancy matches a certain criterion.

22. The managing system of claim 20 further comprising an alerting block operatively connected with the processor, wherein the processor is further configured to define discrepancy among the cross-related data, and the processor and the alerting block are configured to facilitate sending an alert if the defined discrepancy matches a certain criterion.

23. The managing system of claim 20 wherein the data repository is further configured to receive and store a crop growing program and the processor is configured to process at least part of the received data together with at least part of data comprised in the crop growing program so as to define cross-related data and discrepancy thereof.

24. The managing system of claim 23 wherein the processor is further configured to facilitate at least one of operations selected from a group comprising:
(a) deriving one or more recommendations in accordance with defined discrepancy;
(b) updating at least part of the crop growing schedule if the defined discrepancy matches a certain criterion;
(c) sending an alert if the defined discrepancy matches a certain criterion;
(d) deriving at least one control command to be sent to one or more crop growing controllers if the defined discrepancy matches a certain criterion;
and the display is further configured to display at least part of results derived from the operations a) to d).

25. The managing system of claim 20 configured to receive data selected from a group comprising:
(a) operational data;
(b) field data;
(c) landscape data;
(d) crop growing program data;
wherein at least part of said data is received from a source external to the managed crop growing system.

26. The managing system of claim 20 configured to store data selected from a group comprising:
(a) operational data;
(b) field data;
(c) landscape data;
(d) crop growing program data;
wherein at least part of said data is currently received data and at least part of said data is historical data.

27. A method of computerized crop growing management based on a control loop comprising:
(a) receiving operational data and/or derivatives thereof and field data and/or derivatives thereof, thus giving rise to received data;
(b) processing at least part of the received data so as to facilitate verification of operational parameters related to the control loop and to provide a corresponding feedback.

28. A method of computerized crop growing management comprising:
(a) receiving data related to one or more crop growing blocks, and
(b) displaying a crop growing schedule as a bar-chart comprising one or more bars representing time-phased activity durations related to at least part of said crop growing blocks.

29. The method of claim 28 wherein at least one bar comprises information related to at least one information type selected from a group comprising:
(a) status of the represented activity;
(b) at least one planned parameter related to the represented activity;
(c) operational data related to the represented activity;
(d) field data related to the represented activity;
(e) discrepancy between at least one planned parameter and operational data related to the represented activity;
(f) discrepancy between at least one planned parameter and field data related to the represented activity;
(g) discrepancy between field data and operational data related to the represented activity.

30. A computerized program storage device readable by machine, tangibly embodying a program of instructions executable by the machine to perform method steps of crop growing management comprising:
(a) receiving operational data and/or derivatives thereof and field data and/or derivatives thereof, thus giving rise to received data;
(b) processing at least part of the received data so as to define at least one type of results selected from a group comprising:
i) cross-related data among the received data;
ii) discrepancy among the received data;
iii) status of at least part of activities comprised in a crop growing schedule, wherein said status is defined based on the received data.

31. A computerized computer program product comprising a computer useable medium having computer readable program code embodied therein of crop growing management the computer program product comprising:
(a) computer readable program code for causing the computer to receive operational data and/or derivatives thereof and field data and/or derivatives thereof, thus giving rise to received data;
(b) computer readable program code for causing the computer to process at least part of the received data so as to define at least one type of results selected from a group comprising:
i) computer readable program code for causing the computer to define cross-related data among the received data;
ii) computer readable program code for causing the computer to define discrepancy among the received data;
iii) computer readable program code for causing the computer to define a status of at least part of activities comprised in a crop growing schedule, wherein said status is defined based on the received data.
